(19) United States
(12) Patent Application Publication
(10) Pub. No.: US 2006/0090926 A1
(43) Pub. Date: May 4, 2006

(54) Device for the insulation of an electric conductor

(75) Inventor: Thomas Baumann, Wettingen (CH)

Correspondence Address: DAVIDSON, DAVIDSON & KAPPEL, LLC, 485 SEVENTH AVENUE, 14TH FLOOR, NEW YORK, NY, 10018, US

(73) Assignee: ALSTOM Technololgy Ltd., Baden (CH)

(21) Appl. No.: 11/264,393

(22) Filed: Nov. 1, 2005

(30) Foreign Application Priority Data
Nov. 1, 2004 (CH) CH 01804/04

(51) Int. Cl. H01B 3/00

(52) U.S. Cl. 174/138 C

(57) ABSTRACT

A device for insulating an electric conductor includes a non-woven substrate made of fibers and configured to be electrically insulating and a coating containing mica disposed on the fibers.

### FIELD OF THE INVENTION

The present invention relates to a device for insulating an electric conductor.

### DESCRIPTION OF RELATED ART

Rotating electric machines such as, for example, generators, usually have a rotating rotor and a stationary stator, both the rotor and the stator having a plurality of windings made of electrically conductive material. Electric current flows through the windings on the stator as well as through those on the rotor. In order to prevent short-circuits, the windings of the stator or of the rotor have to be electrically insulated. Conventional insulators are made, for instance, of plastic or of a non-conductive fabric containing fiberglass, with a mica layer arranged thereupon.

### SUMMARY OF THE INVENTION

This is where the present invention comes in. The invention as characterized in the claims relates to the objective of providing an improved embodiment for a device of the above-mentioned type by device of which, in particular, an effective insulation of an electric conductor can be achieved inexpensively and so as to be easily adaptable in terms of its dimensions.

According to the invention, this objective is achieved by the subject matters of the independent claims. Advantageous embodiments are the subject matter of the dependent claims.

The invention is based on the general notion of making a device for insulating an electric conductor out of a non-woven, electrically insulating and fibrous substrate onto which a coating containing mica is applied. In this context, the coating consists partially or completely of mica particles that are normally present in the form of flakes, as a consequence of which they are referred to as mica flakes. The non-woven substrate made of fibers offers the major advantage that it can be produced much less expensively than woven substrates and moreover, it can be easily cut and draped as well as shaped without fraying at the edges. Furthermore, the width of the requisite insulating tapes can easily be adapted since they can easily be cut by a cutting machine into the desired width while, at the same time, retaining an edge that is crisp and not frayed, which allows a reliable and high-quality insulation of the component.

On the basis of a first embodiment of the solution according to the invention, the coating containing mica is mica paper. Mica paper normally consists of mica flakes arranged in the paper plane and optionally of a suitable binder that can be, for example, of organic origin. Mica paper makes it possible to create a particularly reliable insulation since the mica material prevents disruptive discharges even if the insulation has defects (for instance, cavities).

Advantageously, the fibers of the substrate are held together by a binder. The bonding of the fibers can be executed, for instance, as thermal and/or chemical bonding. This allows the use of a binder that is aimed at the particular application case and thus permits an especially high flexibility in terms of the binders or materials used.

In another embodiment of the invention, the substrate consists of polyester fibers. Polyester fibers can be produced inexpensively in virtually any size and shape and can easily be bonded by device of a chemical binder to form the non-woven substrate. Here, another conceivable approach is a thermal bond in which the polyester is heated in order to create the bond. Since polyester fibers can be produced inexpensively, they can also be used to inexpensively produce the corona protection device.

Advantageously, the coating containing mica is calandered with and/or glued to the substrate. During calandering, the components to be joined, the substrate and the coating containing mica are rolled and heated. Here, it is possible to employ a powdered adhesive that is applied at previously specified places on the mica paper and/or on the substrate. It is likewise conceivable to spread only one component of a two-component reaction resin onto the substrate and/or the coating. In this case, the second component can be contained, for example, in the impregnation resin that is subsequently applied.

Additional features and advantages of the device according to the invention can be gleaned from the subordinate claims, from the drawings and from the accompanying figure description, with reference to the drawings.

### BRIEF DESCRIPTION OF THE DRAWINGS

Preferred embodiments of the invention are shown in the drawings and are explained in greater depth in the description below, whereby the same reference numerals are employed for the same or similar or functionally equivalent components. The following is shown in schematic form:

FIG. 1 an electric conductor in the area of a slot of a stator with a device according to the invention for insulating the conductor,

FIG. 2 a cross section through the electric conductor with an insulation device according to the invention,

FIG. 3 a partially cut-away view of the coated side of the insulation device.

### WAYS TO EXECUTE THE INVENTION

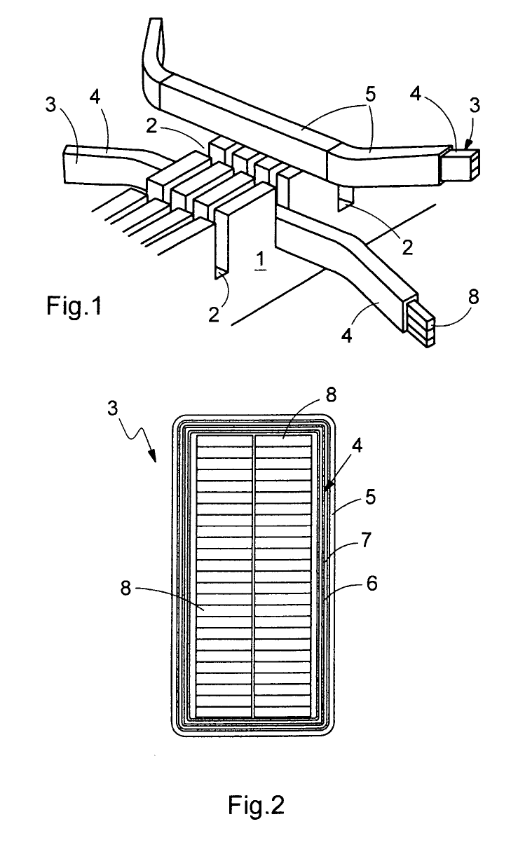

As shown in FIG. 1, a stator 1 has several slots 2 through each of which at least one electric conductor 3 runs. The stator 1 can be made, for example, of iron and thus be electrically conductive and magnetic, and can be part of a generator and/or electric motor (not shown here). In order to prevent the current flowing in the electric conductor 3 from being transferred to the stator 1, the conductor 3 is provided with an insulation 4 that has a high electric resistance. The insulation device 4 can also be referred to in short as insulation 4.

According to FIG. 2, the electric conductor 3 has several part of the conductors 8 that are combined into packets and sheathed by the insulation 4. Here, corona protection 5 is installed around an the external surface of the insulation 4, preferably wound onto it, namely, in the form of an external corona protection that consists of a slot corona shield and of a stirrup corona shield. Depending on the desired insulating effect, the insulation device 4 can have several layers and be wound around the conductor 3 so as to overlap widthwise.

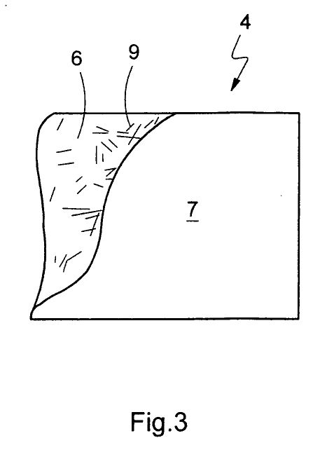

The insulation device 4 or insulation 4 has a non-woven substrate 6 that is made of fibers 9, that is configured so as to be electrically insulating, and that has a coating 7 containing mica (see FIG. 3). The coating 7 containing mica can be configured, for instance, as mica paper. This offers the possibility to apply the coating 7 onto the substrate 6 by means of a calandering method. Thanks to the calandering, the insulation device 4 can be produced with a high quality and at a low cost. The mica paper preferably consists of many small mica scales or flakes arranged in the paper plane. Moreover, a binder, especially an organic binder, can be provided for the bonding.

As is shown in FIG. 3, the fibers 9 can be unoriented in the non-woven substrate 6, as a result of which essentially isotropic properties, especially in terms of the tensile strength, can be ensured. However, it is also conceivable for the fibers 9 to be at least partially oriented and consequently for the substrate 6 to have anisotropic properties. For example, a fiber orientation in the machine direction can be advantageous. Examples of fibers 9 include, for example, polyester fibers which, on the one hand, are inexpensive to produce and, on the other hand, are easy to process. In general, any kind of electrically insulating glass, mineral or synthetic fiber is a possibility. Depending on which fibers 9 are used, different masses per unit area ranging from about 20 g/m² or 30 g/m² up to several hundred g/m² can be realized.

In order to ensure a certain tensile load in the plane of the substrate 6, the fibers 9 are held together by a binder. Such a binder can be, for example, a reaction resin and/or another chemically activated adhesive. Of course, it is also conceivable for the fibers 9 to be joined together through heating in a thermal joining process.

By using the non-woven substrate 6 according to the invention with the coating 7 arranged thereupon, the insulation device 4 not only can be produced inexpensively, but it also offers the possibility that it can be cut simply and precisely into strips of different widths. In contrast to insulating tapes with a woven substrate, which can fray at the edges when they are cut, the insulation device 4 according to the invention retains a precise and crisp edge that does not exhibit any tendency to fray, even after being cut.

Thanks to the fact that the non-woven substrate 6 can be cut without problems, it is conceivable to first produce a wide web of substrate, to coat it and to subsequently cut it according to the requirements, thus saving costs. Consequently, it is not necessary to determine the width of the insulation tape ahead of time. Moreover, due to the relatively small thickness of the insulation device 4, approximately 0.2 mm, multiple layers can be wound around the conductor 3.

### LIST OF REFERENCE NUMERALS

1 stator
2 slot
3 electric conductor
4 insulation/insulation device
5 corona protection
6 substrate
7 coating
8 part of the conductor
9 fibers

1-12. (canceled)

13. A device for insulating an electric conductor, the device comprising:
a non-woven substrate made of fibers and configured to be electrically insulating; and
a coating containing mica disposed on the fibers.

14. The device as recited in claim 13, wherein the coating containing mica is mica paper.

15. The device as recited in claim 14, wherein the mica paper has at least one of mica particles and mica flakes arranged in a plane of the paper.

16. The device as recited in claim 13, wherein the coating is one of calandered with and glued to the substrate.

17. The device as recited in claim 13, wherein the substrate is fleece-like.

18. The device as recited in claim 13, wherein the substrate has a weight of less than 100 g/m².

19. The device as recited in claim 13, wherein the substrate includes at least one of polyester fibers and blended fibers made of glass or polyester.

20. The device as recited in claim 13, wherein substrate includes a binder holding the fibers together.

21. The device as recited in claim 13, wherein the fibers are oriented in a preferred orientation.

22. The device as recited in claim 21, wherein the preferred orientation is aligned with a machine direction.

23. An electric machine, comprising:
a stator;
a rotor; and
an insulation device disposed on at least one of the stator and the rotor, wherein the insulation device includes a non-woven substrate made of fibers and configured to be electrically insulating and a coating containing mica disposed on the fibers.

24. The electrical machine as recited in claim 23, wherein the electrical machine includes at least one of an electric motor and a generator.
